(19) United States
(12) Patent Application Publication
(10) Pub. No.: US 2024/0267065 A1
(43) Pub. Date: Aug. 8, 2024

(54) WIRELESS DISTRIBUTED SENSING

(71) Applicants: Jerry Bark, White Bear Lake, MN (US); Vivek Salunke, Maple Grove, MN (US); Yilmaz Bayazit, Minneapolis, MN (US); Andrew Bentley, Forest Lake, MN (US); Steven Rovert Stadler, Shoreview, MN (US); Russell Oberg, Beldenville, WI (US); Joel Vanderaa, New Brighton, MN (US); Evan Woodard, Raleigh, NC (US); Michael Holsather, Minnetonka, MN (US)

(72) Inventors: Jerry Bark, White Bear Lake, MN (US); Vivek Salunke, Maple Grove, MN (US); Yilmaz Bayazit, Minneapolis, MN (US); Andrew Bentley, Forest Lake, MN (US); Steven Rovert Stadler, Shoreview, MN (US); Russell Oberg, Beldenville, WI (US); Joel Vanderaa, New Brighton, MN (US); Evan Woodard, Raleigh, NC (US); Michael Holsather, Minnetonka, MN (US)

(21) Appl. No.: 18/431,488

(22) Filed: Feb. 2, 2024

Related U.S. Application Data
(60) Provisional application No. 63/443,097, filed on Feb. 3, 2023.

(51) Int. Cl. H04B 1/03; H04B 1/08; H04B 1/40

(52) U.S. Cl. CPC H04B 1/03; H04B 1/08; H04B 1/40

(57) ABSTRACT

Disclosed herein are systems and methods for indoor environmental quality monitoring and other environmental monitoring. A monitoring system can include at least two sensor modules to communicate in a network. The sensor modules can each include communication circuitry and a sensor to generate an output signal based on a measured parameter. The monitoring system can include gateway communication circuitry in wired or wireless communication with the sensor modules to receive measured parameter information and to provide the measured parameter information to a remote apparatus. The monitoring system can include a communication device to provide device configuration information to the sensor modules. The monitoring system can include a cradle having a cavity to receive the communication device.

### RELATED APPLICATION

The application claims the benefit of priority to U.S. Provisional Application Ser. No. 63/443,097, filed Feb. 3, 2023, the content of which is incorporated by reference in its entirety.

### FIELD OF THE DISCLOSURE

This document pertains generally, but not by way of limitation, to a wireless sensor and remote monitoring. More specifically, the disclosure relates to environmental quality measurements taken with wireless sensing systems.

### BACKGROUND

Environmental meters and monitors provide building maintenance professionals with the tools they need to configure ventilation systems or to check the environmental quality of various workspaces. A number of these devices typically include a handheld device provided with a probe or sensor. However, these and similar devices are typically not configurable for different uses and often have no user interface or a simplistic user interface.

In addition, handheld devices in use today have no provision for data aggregation and visualization at a single screen. Customers are required to manually configure and control multiple instruments to perform these measurements. Still further, it can be expensive to provide continuous monitoring of a pre-selected area of a building, and security concerns can arise when placing sensors around various locations. Time delays can occur when analyzing and interpreting sensor data, which can impact emergency response especially when sensors are placed at a network or system edge.

### SUMMARY

Disclosed herein are systems and methods for continuous, intermittent, or survey-based measurement of environmental quality, air velocity, and other parameters within an indoor area such as a factory, office building, or other public or private structure. As disclosed herein, a monitoring system can include sensor modules configured to communicate with each other on a network. Gateway communication circuitry can be in wired or wireless communication with at least one of the sensor modules. The gateway communication circuitry can receive measured parameter information from the at least two sensor modules and to provide the measured parameter information to a remote apparatus for data logging and aggregation. The monitoring system can also include a communication device to provide device configuration information to at least one of the at least two sensor modules, and a cradle to receive the communication device for handheld survey monitoring or other modes of monitoring. While a cradle is described, other embodiments can provide a tablet, smartphone or other user interface-capable device during survey or intermittent modes or other modes.

Another monitoring system can include a communication device. The communication device can include a user interface, a processor, wireless telemetry, and memory. This monitoring system can also include a cradle having a cavity to receive the communication device. A sensor module within this system can include wireless telemetry and a sensor to generate an output signal based on a measured parameter.

A device according to some example embodiments can include a housing having a cavity configured to receive a wireless communication device. The device can include a sensor module engagement feature coupled to the housing, the sensor module engagement feature configured to enable mechanical coupling with a sensor module and configured to enable mechanical decoupling with the sensor module, wherein the mechanical coupling and the mechanical decoupling are tool-less.

### BRIEF DESCRIPTION OF THE FIGURES

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 illustrates a system for implementing survey or intermittent monitoring according to some example embodiments.

FIG. 2 illustrates a system for implementing continuous monitoring according to some example embodiments.

FIG. 3 illustrates an example sensor module decoupled from a cradle according to some embodiments.

FIG. 4 illustrates mechanical coupling of a sensor module and cradle according to some embodiments.

FIG. 5 illustrates hardware architecture for the sensor module and associated computer systems according to some embodiments.

FIG. 6 illustrates sensor telemetry dataflow according to some embodiments.

FIG. 7 illustrates further detail of data flow between a user device and sensor according to some embodiments.

FIG. 8 illustrates an example machine learning module for controlling indoor environmental quality and air flow, according to various embodiments.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

Building maintenance professionals often use environmental quality meters and monitors to monitor indoor environmental quality, plan ventilation systems, measure inhalation and noise hazards, and to perform other similar tasks. Professionals can use different handheld devices to perform these monitoring tasks. However, available devices suffer from various deficiencies. First, many available devices used for survey a building/environment are single integrated designs with limited user interface. There is no flexibility to detach the sensor from an available user interface to place the sensor in a suitable location for measuring or monitoring, and devices are not configurable for different applications.

In addition, available devices are standalone devices with no provision for data aggregation and visualization. Customers are required to manually configure and control multiple instruments to perform these measurements. In many cases customers must walk around their facility/building and manually take measurements, which is time consuming and tedious.

Further, there is no flexibility for different measurement scenarios. A survey scenario, intermittent measurement scenario, and continuous monitoring scenario each have unique sensor configuration needs. Customers today typically use completely different devices for each scenario rather than taking advantage of any synergies that could be obtained by configuring one single device or group of devices to work in various scenarios.

Current solutions also typically display readings on instrument displays. There is currently little to no integration of tools to improve productivity of the operator while taking multiple readings at specified locations in the site. In the case of toxic gas measurement/detection, although current solutions collect accurate data, significant analysis and interpretation by the customer is required to interpret the results. Because this can take some time, dangerous toxic gas situations can develop before any action is taken.

Systems and devices according to various embodiments address these and other concerns using connected sensor modules in conjunction with user display devices, system gateways and other connectivity to remote systems for aggregated and more efficient data monitoring. Various aspects and system configurations are described in the sections below.

The above discussion is intended to provide an overview of subject matter of the present patent application. It is not intended to provide an exclusive or exhaustive explanation of the invention. The description below is included to provide further information about the present patent application.

Systems in which Example Embodiments can be Implemented

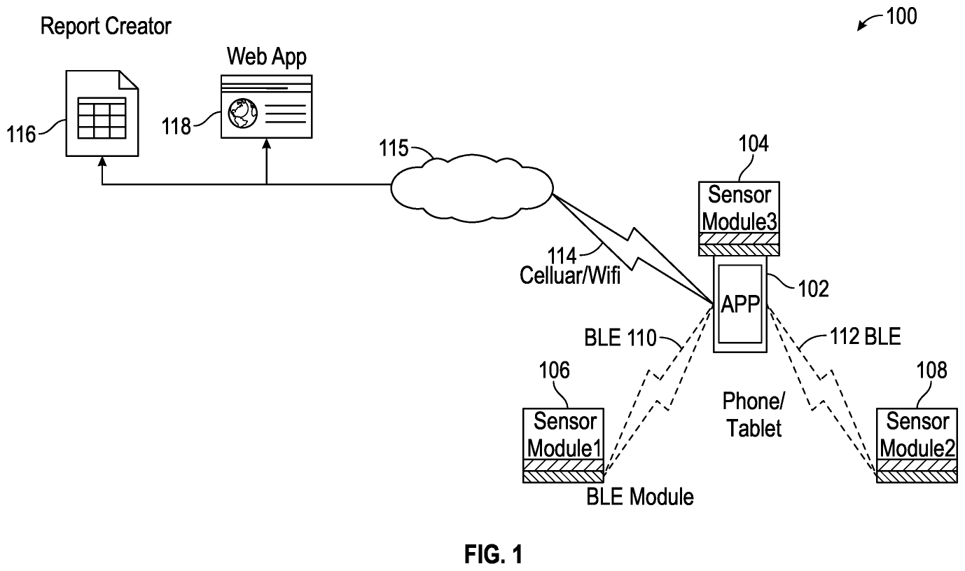

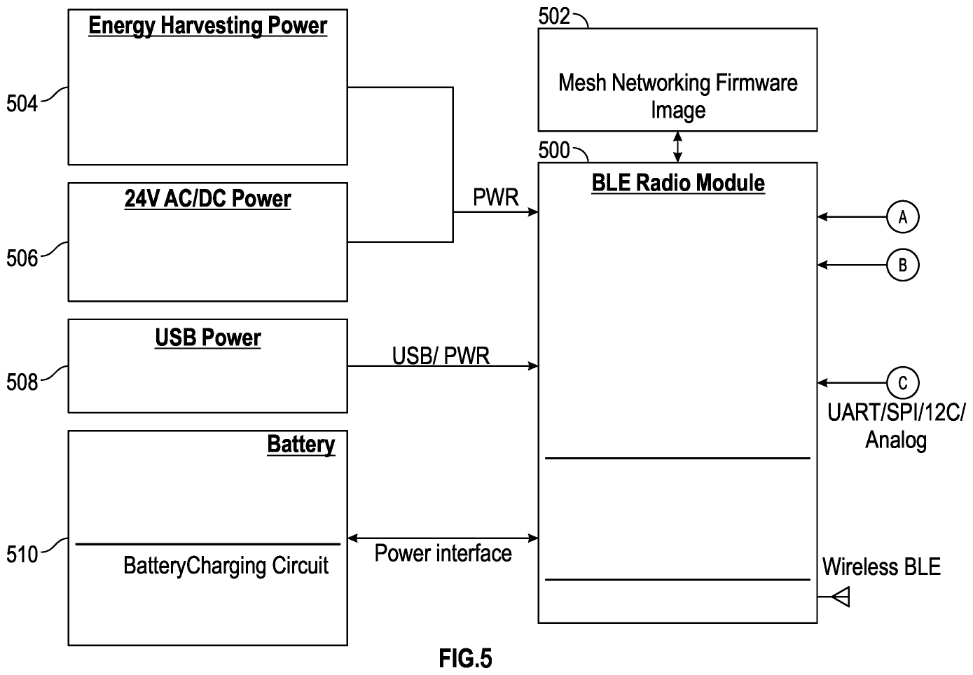

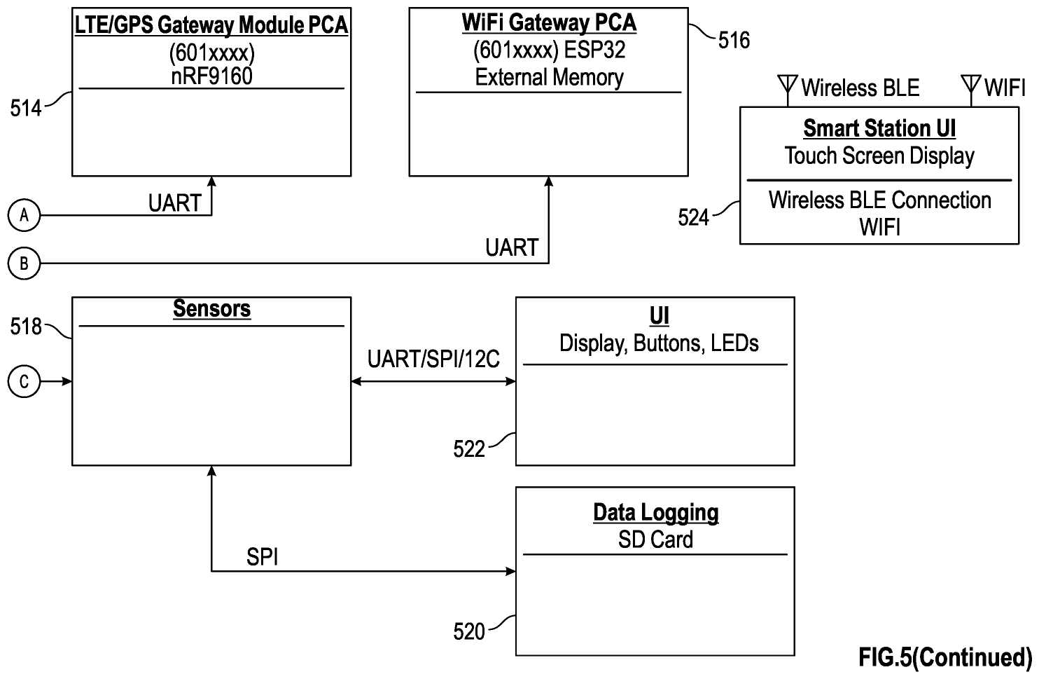

FIG. 1 illustrates a system 100 for implementing survey or intermittent monitoring according to some example embodiments. The system 100 can include a communication device 102. The communication device 102 can have any circuitry described with reference to FIG. 5, including at least a user interface, a processor, telemetry circuitry, memory, etc.

The system can include one or more cradles having a cavity to receive the communication device, wherein the cradle is described in more detail below. While a cradle is described, other embodiments can provide a tablet, smartphone or other user interface-capable device during survey or intermittent modes or other modes.

The system 100 can include at least one sensor module 104, 106, 108 each having telemetry circuitry and other circuitry as described later herein. Sensor module 104, 106, 108 each further include a sensor configured to generate an output signal based on a measured parameter, and a sensor housing. Sensor module/s 104, 106, 108 can communicate with each other via connections 110, 112 and through other connection/s 114, 115 to remote systems 116, 118. Remote systems 116, 118 can include report creators, web-based applications, etc.

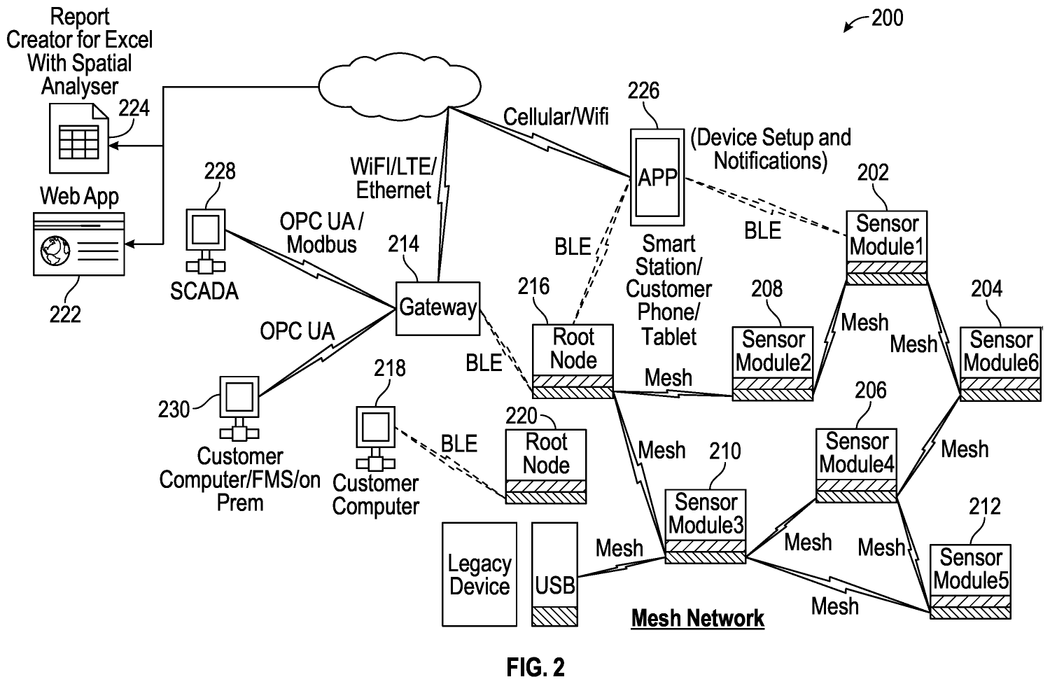

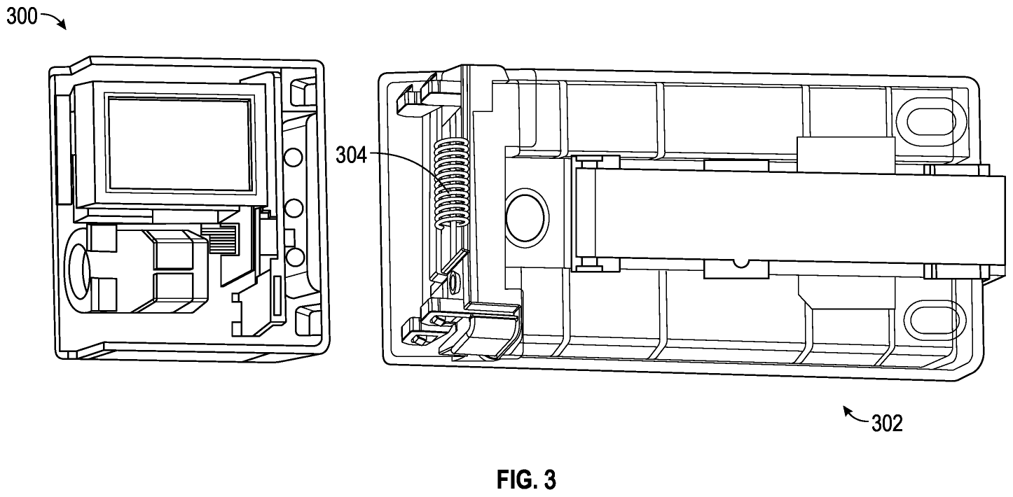

FIG. 2 illustrates a system 200 for implementing continuous monitoring according to some example embodiments. The system 200 can include sensor modules 202, 204, 206, 208, 210, 212 configured to communicate in a self-healing network (e.g., a mesh network). A self-healing network in the context of embodiments can refer to a network in which removal or failure of a node can result in replacement or reconfiguration of failed nodes or devices. Failure can be predicted by artificial intelligence or other methodologies to prevent halting of network traffic. A sensor module 202, 204, 206, 208, 210, 212 can include communication circuitry and a sensor configured to generate an output signal based on a measured parameter. The system 200 can include any number of sensor modules, root nodes, etc.

The system 200 can further include gateway communication circuitry 214 in wired or wireless communication with at least one sensor module 202, 204, 206, 208, 210, 212 through, e.g., a root node 216. Other computing devices 218 can also communicate with root nodes 220 or other nodes. The gateway communication circuitry 214 can receive measured parameter information from sensor modules 202, 204, 206, 208, 210, 212 and provide the measured parameter information to a remote apparatus 222, 224. Remote apparatus 222, 224 can include report creators, web-based applications, etc. The system 200 can include a communication device 226. The communication device 226 can have any circuitry described with reference to FIG. 5, including at least a user interface, a processor, telemetry circuitry, memory, etc.

The system 200 can further include other devices such as a supervisory control and data acquisition (SCADA) system 228 for controlling, monitoring and analyzing sensor data in, for example, embodiments implemented in industrial applications. Other customer computer/s 230 can also be used to gather, display, aggregate, monitor, etc. any sensor data received from sensor module 202, 204, 206, 208, 210, 212. System/s 228 and 230 can be in communication with the gateway communication circuitry 214.

Systems 100, 200 can be used to perform any embodiments described below, and/or can include any components described below.

### Sensor Usage and Data Visualization

Any of the sensors or sensor modules described with respect to system 100 and system 200 can be provided within flexible, configuration systems, with the ability to perform data visualization either locally at the sensor or at a remote location. In one example, a sensor module includes a mechanical feature that cooperates with a mechanical feature of a cradle and allows for docking or undocking the sensor module relative to the cradle. In one example, a sensor module includes a mechanical feature that cooperates with a mechanical feature of a second sensor module, thereby allowing for multiple sensor modules to mechanically connect together. A user-operable button or actuator accessible on a surface of the cradle allows for release of the hooks and disengagement of the sensor module from the cradle. A ramped surface associated with the mechanical feature of either the sensor module, the cradle, or both the sensor module and the cradle, allows for tool-less engagement of the sensor module and the cradle.

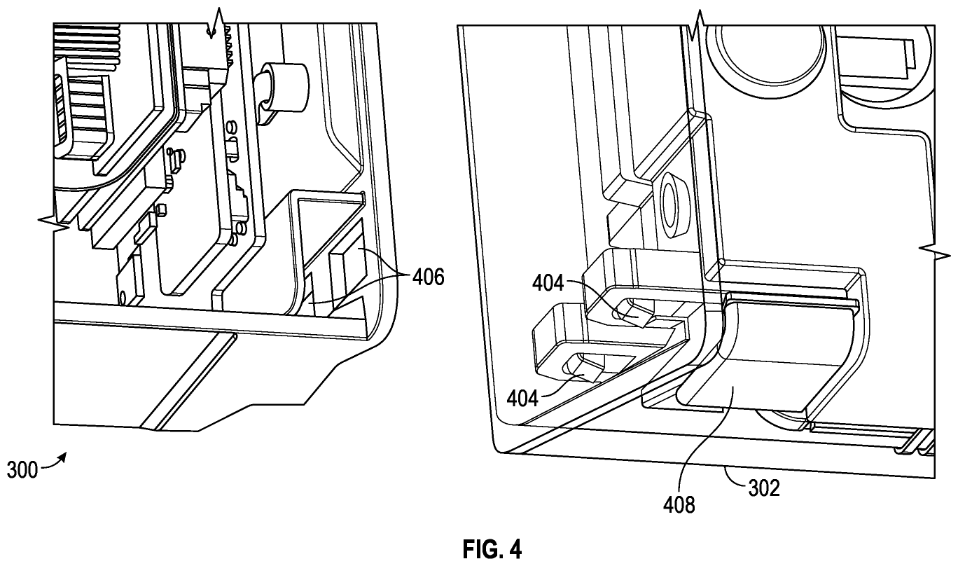

FIG. 3 illustrates an example sensor module 300 decoupled from a cradle 302 according to some embodiments. The sensor module 300 can include a housing, a power supply, a sense device, an electrical circuit, and memory for storing executable instructions and data. The housing of the sensor module 300) can include features to mechanically engage the sensor module 300 with a cradle 302.

The sensor module 300 power supply can include a battery or energy storage device. The sense device of a sensor module 300 can be configured to detect or measure any of a number of parameters. In various examples, the sense device provides an output corresponding to TVOC, carbon dioxide (CO2), formaldehyde (CH2O), carbon monoxide (CO), amino group compounds (NH2), chlorine (CI), hydrogen sulfide (H2S), ammonia (NH3), nitric oxide (NO), nitrogen dioxide (NO2), ozone (O3), or other gases. In addition, the sense device can provide an output corresponding to a sensed flow (gas or liquid), LCOPC (low-cost particle sensor), PM 2.5, sound level (such as class 1 sound), heat stress, temperature, relative humidity, acceleration, vibration, or other parameter.

The sensor module 300 can include any other circuitry or components including telemetry, display, processing circuitry etc. as described below with reference to FIGS. 5-9.

The sensor module 300 and cradle 302 are physically coupled by a mechanical interface. In one example, an audible ‘click’ confirms engagement of the sensor module 300 with the cradle 302. The sound is associated with a spring-loaded assembly 304 (FIG. 3) that simultaneously locks the sensor module 300 to the cradle 302 and forcefully moves a dynamic component against a rigid mechanical constraint (such as a wall), thus emitting the audible click sound.

Another coupling example can be similar to that shown in FIG. 4. FIG. 4 illustrates mechanical coupling of a sensor module 300 and cradle 302 according to some embodiments. In FIG. 4, the sensor module 300 is held firm by the cradle 302 using a plurality of locking features 404 and mechanical constraints 408 to ensure a solid coupling. In one example, four locking features 404 are configured to provide a robust connection with corresponding elements denoted here as complementary features 406.

In addition to the examples shown in FIG. 3 and FIG. 4, one example of a sensor module includes a repositionable kick-stand-type support, hand strap, wrist wrap, or a standard attachment feature to accommodate a tripod mount.

One example of a sensor module includes a standardized form of firmware and software. This can include a standardize transport protocol, HAL, bootloader etc. and with configurability option in data logging module, sensor driver, calibration module, UI module etc. to support various applications.

In one example, the sensor module includes a rechargeable battery. When the sensor module is coupled to a cradle, the sensor module battery is automatically charged. Charging is accomplished via a direct electrical coupling between the sensor module, the cradle, and the communication device, or the charging is accomplished between the communication device and the sensor module by an inductive coupling.

In one example, the sensor module includes a connector to receive electric power. Electrical power can be carried by a USB connector or by a wall connection (such as a 24 v power supply).

One example includes a sensor module comprising a housing having a sensor coupled to a telemetry module. Such a modular approach allows for greater flexibility in sensing and improved data visualization. A sensor module can be configured for various applications, thus providing a flexible and cost-effective solution for monitoring.

In one example, the sensor module is configured to be mechanically coupled, or mounted, to a cradle of a remote monitor. The cradle provides a housing or a case for the communication device and allows for one-handed operation suitable for surveying a sensor module.

The sensor module can be detached from the cradle and affixed to, configured, or placed, at a measurement site. The modular configuration and small form factor enables measuring a parameter in difficult or tortious locations. Examples include monitoring aerosol plumes in a sterile surgical suite or monitoring particulate levels in a supply duct above a finished ceiling. The wireless and detachable configuration allows a user to receive data, control an actuator, and view data at a remote site.

In one example, the sensor module can be detached from the cradle and configured for unattended, multi-hour data logging. The sensor module can be placed in an innocuous location to reduce tampering with the sensor or other equipment. The remote monitor user can view measurement data in real-time while within wireless communication range. This configuration also allows the communication device to be accessed for other processing or measurement tasks.

In one example, the sensor module can be mechanically coupled to a cradle for continuous monitoring. In one example, the cradle is configured for use with a communication device that provides data to a wireless communication channel. The sensor module can provide utility when no survey measurements are needed.

In contrast to the subject matter disclosed herein, some commercial products deployed for handheld survey work are unitary devices incapable of remote monitoring and offering only a limited user-interface and limited flexibility for operating with a user-selected sensor or with multiple different sensors.

In one example, the sensor module can be mechanically attached to the cradle. The cradle is configured to receive a communication device. In one example, the cradle is configured to mechanically couple with more than one sensor module at a time. The sensor module, or sensor modules are fully functional whether attached to a cradle or detached from a cradle.

In one example a mechanical interface provides a connection between the sensor module and the cradle. The sensor module communicates with the communication device via a wireless communication channel. In one example, the sensor module communicates via Bluetooth. In one example, a first sensor module wirelessly communicates with a second sensor module via a network.

### Concurrent Sensor Measurement

Some handheld devices used for survey are incapable of providing data aggregation and visualization at a single screen. To provide such measurements, a user is required to manually configure and control multiple separate instruments.

In one example of the present subject matter, a plurality of sensor modules are controllable from a single interface accessible from a single communication device. In one example, the remote monitor and the sensor modules are connected using a local wireless network, such as Bluetooth and accordingly sensor modules can include Bluetooth transceiver circuitry transceiver circuitry capable of communicating using any other communication standard. Data from the plurality of sensor modules are automatically aggregated with a synchronized time stamp. The sensor data is integrated to derive useful insights for customer using customized algorithms and machine learning models.

One example of the present subject matter allows for modularity and flexibility for sensing parameters using multiple sensor modules at a time with data aggregation and visualization at a single user interface.

For example, some measurements require simultaneous operation of several instruments. One example pertains to measuring ventilation effectiveness. A system having five total volatile organic compound (TVOC) sensors can be placed within a room to simultaneously monitor the rise and decay of an aerosolized agent. Another example pertains to speech privacy. A plurality of sensors can be distributed in a room and surrounding areas to sim simultaneously measure an impulse noise (balloon burst). Another example pertains to measuring filtration performance. Sensor modules are placed both upstream and downstream of an air cleaning device to compute the filtration performance ratio.

One example of the present subject matter provides modularity which enables a remote monitor to a broad range of dynamically changing sensor modules. For example, at a first time, a cradle can be configured to couple with four sensor modules, and at a second time, the same cradle can be configured to couple with six sensor modules, all of which exchange data with the communication device within the cradle.

Multiple sensor modules can be mechanically attached or detached and the user interface executing on the communication device allows for presenting multiple data streams on a single interface. This allows a user to adjust the type, placement, and number of sensor modules as conditions change. For example, the user interface can be configured to display data from each sensor module in a discrete window, or display data from each sensor module in a single window.

In one example, a plurality of spatially distributed sensors can allow for comparative data analytics. For example, a selected parameter can be measured at multiple sites in a production facility and relative or differential parameters can be calculated and the data rendered on the communication device. By way of another example, sensor data can be correlated with other data. Air cleaner performance can be monitored by analysis of particulate matter measurements relative to sound pressure levels, and thus, adjust air handling equipment to achieve a desired filtration and sound level.

In one example, the communication device can be configured to provide sensor data (from one or a plurality of sensor modules) to a wide area network. One example of a wide area network includes a cloud-based connection. The communication device can include a touch-sensitive screen for controlling operation of the device. The communication device can be linked to a particular sensor module using a handshaking routine known as pairing in the context of Bluetooth.

In the event a sensor module is unable to wirelessly communicate with the remote monitor, one example of the present subject matter provides for continuous monitoring and buffering of sensor data in a memory device at the sensor module. When the communication channel is available, the sensor module telemeters the buffered sensor data to the remote monitor.

### Augmented Reality Integration

In one example, the communication device includes a smartphone with an integrated web browser. The smartphone can include a cellular telephone or can include a modified device having disabled or enhanced features.

In one example, an integrated web browser provides access to web-based tools and AR (augmented reality) in the system. According to one example, a system includes a floorplan visualization tool. The floor plan visualization tool allows a user to view prescribed measurement points to be measured directly on the building floorplan either using the communication device display or using a wearable device (such as a headset, heads-up-display, or eye glasses) that provides augmented visual display. The floor plan visualization tool provides landmarks and reference elements to assist in orienting the user.

A visual depiction of sensor locations or measurement sites can allow improved efficiency in terms of sensor module placement and measurement data. According to one example, proposed target locations for sensor module placement are depicted in an augmented reality display. According to one example, actual sensor module locations are depicted in an augmented reality display to facilitate survey application monitoring.

Location data can be provided by a global positioning system or by a navigation system including an inertial measurement unit.

In one example, the user interface executing on the communication device allows a user to interact in real time with another user for collaborating on sensor module location or measurement sites.

### Hazard Identification and Alerts

In one example, a sensor module can be configured to detect a hazardous condition. The hazardous condition can include a toxic gas, temperature extremes, or other environmental dangers. For example, a silica particulate sensor can identify an environment in which a user should be equipped with a protective mask.

In one example, a TVOC sensor module collects data concerning TVOC and particulate matter sensor data. This sensor data can be analyzed using an algorithm (including, for example, machine learning) to identify targeted hazardous toxic gases in specific environment applications. The sensor module can be configured with a processor to execute such an algorithm and if conditions warrant, provide a notification signal. The notification signal can include any combination of local or remote audible signaling, local or remote visual signaling, reporting to other devices, and data logging. For example, an alert signal can report magnitude and duration of exposure.

In one example, the sensor module executes an algorithm using a local processor accessible to the sensor module or included in the sensor module. Executing in an edge located device provides rapid response time. A variety of hazardous or toxic gases can be detected including carbon monoxide, nitrous oxide, etc.

### Monitoring Modes and Architecture of Monitoring Systems

Referring again to FIG. 1 and FIG. 2, an example of the present subject matter can be configured to enable monitoring using any combination of Survey mode, a Continuous mode, and an Intermittent mode. The capability provides standardization and an economy of scale for optimizing inventory and reducing costs. The sensor module configurations and mounting mechanisms described above can be adapted to perform any of the monitoring modes described herein.

Survey, intermittent and continuous monitoring have unique requirement as well as various synergies between them. Currently, customer uses unique instruments for these applications scenarios. This solution enables to use the same device for all three applications, thus providing an excellent flexibility and utilization at customer end. This also provides significant standardization and an economy of scale for optimizing the inventory at manufacturing.

A survey monitoring application typically entails a handheld device (e.g., device 102) used for recording data on an as-needed basis corresponding to sensor location at the time of measurement. As such, at least one sensor module is mechanically coupled to a cradle and the communication device, with cradle and affixed sensor modules, is carried from one measurement site to another measurement site. As such, the sensor data is contemporaneous and location or time specific.

A continuous monitoring application can include a large number of sensor modules (e.g., modules 106, 108 (FIG. 1)) physically distributed throughout a facility. The sensor modules 106, 108 can provide data to a remote monitor (e.g., unit 102) on a continuous basis. An example application can include a pharmaceutical production facility in which many sensors throughout the facility provide data to monitor production performance. In some examples, the sensor modules 106, 108 are each discretely coupled in a one-to-one relation with a remote monitor. In some examples, the sensor modules 106, 108 are each coupled in a hierarchical network in which sensor module data is conveyed in a tiered communication network to the monitor. In some examples, the sensor modules 106, 108 are each coupled to one another or to the remote monitor in a mesh network (see e.g., FIG. 2 mesh network).

An intermittent monitoring application entails a hybrid in which, for example, a sensor module records data for a period of time and transmits the data according to a specified schedule.

A sensor module includes hardware configured according to a standard format. The standard format includes aspects specifying mechanical connectivity, wireless connectivity, electric power, and other factors. For example, the sensor modules have configurability options for wireless communication (radio frequency, device-to-application; device-to-device). In one example, the sensor modules are configured to utilize a standard power supply voltage (ranging from 2.7V to 40V), include a memory device, support various communication interface (I2C, UART, GPIO, SPI), battery supply, (Li-ion, sizes such as AA, AAA) configured to support various application scenarios.

FIG. 5 illustrates hardware architecture for the sensor module and associated computer systems according to some embodiments. A sensor module or associated communication circuitry of a sensor module can include a radio module 500. The radio module 500 can include a Bluetooth or Bluetooth Low Energy (BLE) module for performing Bluetooth communication. The radio module 500 can couple to a firmware image 502 to implement frequency hopping algorithms and self-healing mesh routing protocols for operation in a mesh network.

Power can be provided to radio module 500 from, e.g., solar panels or other energy harvesting power systems 504. Power can be additionally or alternatively provided from AC/DC power systems 506, or through a USB cable 508, or through a battery 510.

The radio module 500 can communicate over an interface (e.g., universal asynchronous receiver/transmitter (UART) interface) to gateway communication circuitry including a cellular gateway 514 and/or a WiFi Gateway 516 for communications according to cellular and WiFi standards to other devices, sensors, or interfaces for continuous, intermittent or survey monitoring according to any of the embodiments described herein.

The radio module 500 can communicate using UART, inter-integrated-circuit (12C), serial protocol interface (SPI) etc. to one or more sensors 518 to receive sensor measurements. The sensor/s 518 can provide data for data logging 520 and/or to a user interface 522. A touch screen display or other systems 524 can communicate wirelessly to the radio module 500 using e.g., BLE, WiFi, etc.

Other processing circuitry (e.g., microprocessors, memory, etc.) can be provided in the architecture according to FIG. 5. For example, the architecture can include a processor and memory for storing executable instructions and data. The executable instructions of a sensor module can be configured to process the output from the sense device and determine a hazard condition. In some examples, the sensor module has a user interface to signal a measured condition (audible or visual).

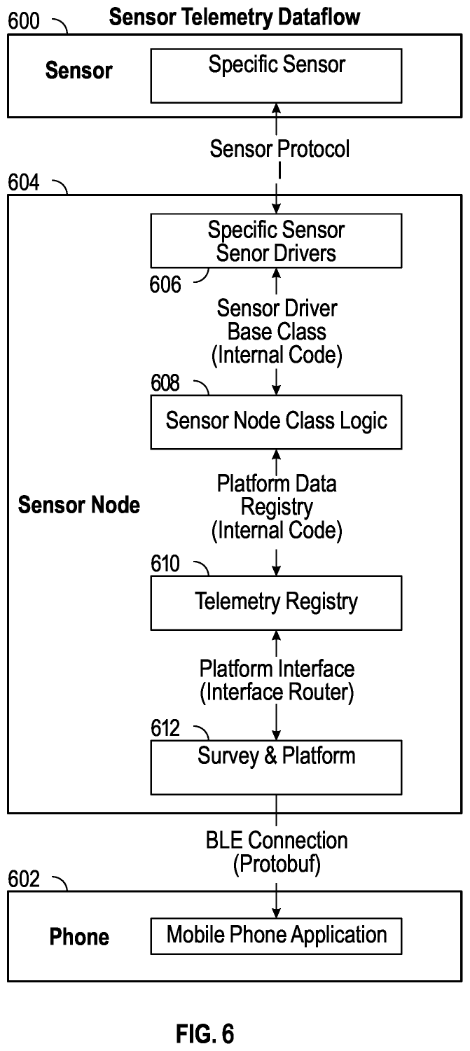

FIG. 6 illustrates sensor telemetry dataflow according to some embodiments. In the example illustrated, a sensor 600 can communicate measurements to a phone 602 or other user device including a display or other user output, through a sensor node 604, which can be similar to the radio module 500 described with reference to FIG. 5. Communications from the sensor 600 to the sensor node can include I2C, any type of serial connection, or other connection. The sensor 600 can include one or more various types of sensors described earlier herein. The phone 602 can operate a mobile phone application designed for displaying sensor data or monitoring system data as described above.

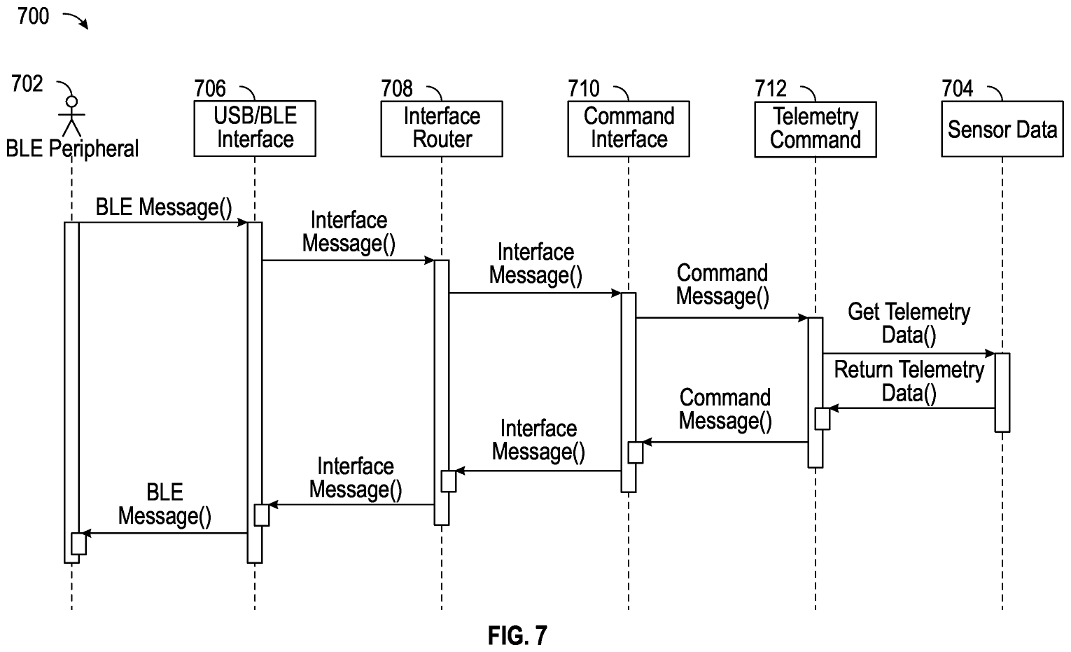

FIG. 7 illustrates further detail of data flow 700 between a user device 702 and sensor 704 according to some embodiments. A user device 702 in the form of for example a peripheral device such as a cell phone, smart phone, remote computer system, tablet, etc. can communicate Bluetooth, BLE or other wireless messages over a wireless interface 706. The wireless interface 706 can communicate interface messages through an interface router 708 to a command interface 710. The command interface 710 can provide command messages to telemetry circuitry 712, and the telemetry circuitry 712 can provide a command to retrieve telemetry data from the sensor 704. The sensor 704 can respond with the requested telemetry data to be provided through telemetry circuitry 712, command interface 710, interface router 708, and wireless interface 706 back to the requesting user device 702.

A sensor protocol can be used to communicate measurements using a driver 606 specific to the particular sensor or specific to a group of similar sensors/sensor types. The sensor driver 606 can provide data to sensor node class logic 608, which comprises a command processor as part of platform code to retrieve/obtain/get sensor data through a sensor driver. The sensor node class logic 608 can provide data to telemetry registry 610, which includes a data protocol to transport sensor data. The telemetry registry 610 can communicate measurement data to the phone 602 over interface circuitry 612. The interface circuitry 612 can include BLE interfaces, mesh, etc.

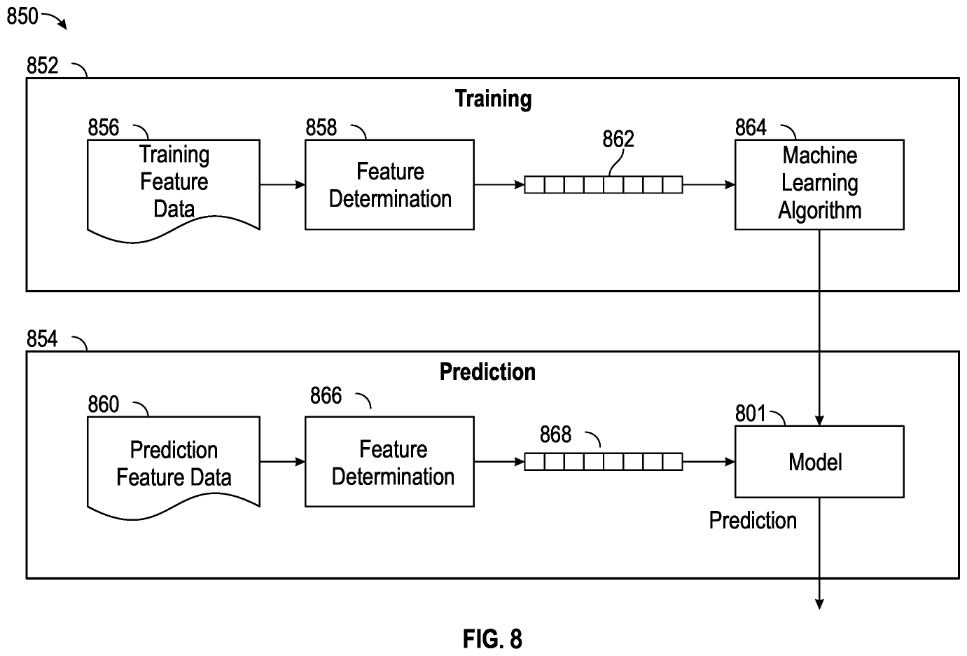

In some examples, the sensor module is configured to execute an artificial intelligence algorithm to identify or classify an output signal from a sense device. In some examples, the sensor module includes an output node to provide a signal to an actuator. The actuator can be configured to manipulate a valve, adjust a temperature setting of a thermal element, adjust a motor speed (fan, pump), or other actuator to provide a control of a system. For example, FIG. 8 illustrates an example machine learning module 850 for environmental quality monitoring and adjustment of air flow parameters, according to various embodiments. The machine learning module 850 may be implemented in whole or in part by one or more computing devices. In some examples, the training module 852 may be implemented by a different device than the prediction module 854. In these examples, the model 801 may be created on a first machine and then sent to a second machine.

Machine learning module 850 utilizes a training module 852 and a prediction module 854. Training module 852 inputs training feature data 856 into feature determination module 858. The training feature data 856 may include data determined to be predictive of identifying hazardous conditions in, e.g., the air for example toxic gases, and predicting mitigation or warning measures. The training feature data 856 may also be used to provide a control signal to increase ventilation or light a warning beacon. Categories of training feature data may include measurement levels or quantities of gases determined to be hazardous.

Specific training feature data and prediction feature data 860 may include, for example actuator controls or valve control signals for mitigating hazardous conditions.

Feature determination module 858 selects training vector 862 from the training feature data 856. The selected data may fill training vector 862 and comprises a set of the training feature data that is determined to be predictive of hazardous conditions. In some examples, the tasks performed by the feature determination module 858 may be performed by the machine learning algorithm 864 as part of the learning process. Feature determination module 858 may remove one or more features that are not predictive of hazardous conditions or mitigation prior to training the model 801. This may produce a more accurate model that may converge faster. Information chosen for inclusion in the training vector 862 may be all the training feature data 856 or in some examples, may be a subset of all the training feature data 856.

In other examples, the feature determination module 858 may perform one or more data standardization, cleanup, or other tasks such as encoding non numerical features. For example, for categorical feature data, the feature determination module 858 may convert these features to numbers.

The training module 852 may operate in an offline manner to train the model 801. The prediction module 854, however, may be designed to operate in an online manner. It should be noted that the model 801 may be periodically updated via additional training and/or user feedback. For example, additional training feature data 856 may be collected. The feedback, along with the prediction feature data 860 corresponding to that feedback, may be used to refine the model by the training module 852.

Prediction feature data 860 can be input to feature determination 866. In some examples feature determination 866 and feature determination 858 are the same. The prediction module 854 can produce feature vector 868 from preprocessed current data, for input to model 801.

In some example embodiments, results obtained by the model 801 during operation (e.g., outputs produced by the model in response to inputs) are used to improve the training data, which is then used to generate a newer version of the model. Thus, a feedback loop is formed to use the results obtained by the model to improve the model.

The machine learning algorithm 864 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims.

What is claimed is:

1. A monitoring system comprising:
at least two sensor modules configured to communicate in a network, a sensor module of the at least two sensor modules including communication circuitry and a sensor configured to generate an output signal based on at least one measured parameter;
gateway communication circuitry in wired or wireless communication with at least one of the at least two sensor modules and configured to receive measured parameter information from the at least two sensor modules and to provide the measured parameter information to a remote apparatus; and
a communication device configured to provide device configuration information to at least one of the at least two sensor modules.

2. The monitoring system of claim 1, wherein the network comprises a mesh network.

3. The monitoring system of claim 1 wherein at least one of the at least two sensor modules includes a Bluetooth transceiver.

4. The monitoring system of claim 1, further comprising a cradle including a first mechanical feature and the communication device includes a second mechanical feature, wherein the first mechanical feature and second mechanical feature are configured to engage and disengage in a tool-less manner.

5. The monitoring system of claim 1, wherein at least one of the at least two sensor modules includes an output to provide instruction to an actuator.

6. The monitoring system of claim 1 wherein at least one of the at least two sensor modules includes a memory device to store measured parameter information.

7. The monitoring system of claim 1 wherein at least one of the at least two sensor modules is configured to transmit data to the communication device.

8. The monitoring system of claim 1, further comprising a cradle configured to be separated and operated separately from the at least two sensor modules.

9. The monitoring system of claim 1, wherein the system is configured to be operated in one of a continuous mode, a survey mode, and an intermittent mode.

10. The monitoring system of claim 1 wherein at least one of the remote apparatus or the at least two sensor modules are configured to include memory for data aggregation.

11. The monitoring system of claim 1 wherein at least one of the remote apparatus or the at least two sensor modules are configured to include a display for data display and a user input for receiving manual control.

12. A monitoring system comprising:
a communication device, the communication device having a user interface, a processor, a first wireless telemetry module, and a first memory device; and
a sensor module having a second wireless telemetry module, a sensor configured to generate an output signal based on at least one measured parameter, and a sensor housing, wherein the first wireless telemetry and the second wireless telemetry module are configured to exchange data with the communication device, and wherein a cradle includes a first mechanical feature and the sensor module includes a second mechanical feature, wherein the first mechanical feature and second mechanical feature are configured to engage and disengage in a tool-less manner.

13. The monitoring system of claim 12 wherein at least one of the first wireless telemetry module and the second wireless telemetry module includes a Bluetooth transceiver.

14. The monitoring system of claim 12 wherein the communication device is configured to provide an instruction to an actuator based on a user input.

15. The monitoring system of claim 12 wherein the sensor module includes a second memory device.

16. The monitoring system of claim 12 wherein the sensor module is configured to transmit data to the communication device.

17. The monitoring system of claim 12 further comprising at least one other sensor module in wireless communication with the communication device.

18. The monitoring system of claim 17, wherein the wireless communication is according to a Bluetooth communication standard.

19. The monitoring system of claim 17, further comprising a user device in communication with the at least one other sensor module and configured to communicate to a remote system.

20. The monitoring system of claim 19 wherein at least one of the remote system, the communication device, or the sensor module includes memory for data aggregation.

21. The monitoring system of claim 19 wherein at least one of the remote system, the communication device, or the sensor module includes a display for data display and a user input for receiving manual control.

22. The monitoring system of claim 19, wherein the communication device is configured to exchange data with the cloud.

23. A device comprising:
a housing having a cavity configured to receive a wireless communication device; and
a sensor module engagement feature coupled to the housing, the sensor module engagement feature configured to enable mechanical coupling with a sensor module and configured to enable mechanical decoupling with the sensor module, wherein the mechanical coupling and the mechanical decoupling are tool-less.

24. The device of claim 23, further comprising a mounting mechanism to mount the device to a surface.

25. The device of claim 23, wherein the wireless communication device is configured to communicate in a mesh network.

26. The device of claim 25, wherein the mesh network is a Bluetooth mesh network.

27. The device of claim 23, wherein the wireless communication device is configured to communicate with a gateway.

28. The device of claim 23, wherein the housing includes a cradle for hand-held device operation.
